(19) United States
(12) Patent Application Publication
(10) Pub. No.: US 2025/0219322 A1
(43) Pub. Date: Jul. 3, 2025

(54) POWER ADAPTER WITH GUIDE MEMBER

(71) Applicant: LANTO ELECTRONIC LIMITED, Kunshan City (CN)

(72) Inventors: Jie LU, Kunshan City (CN); Lichao CAI, Kunshan City (CN); Mingcheng WANG, Kunshan City (CN); Fuqiang WANG, Kunshan City (CN)

(73) Assignee: LANTO ELECTRONIC LIMITED, Kunshan City (CN)

(21) Appl. No.: 18/597,340

(22) Filed: Mar. 6, 2024

(30) Foreign Application Priority Data
Dec. 27, 2023 (CN) 202311813303.0

(51) Int. Cl. H01R 13/629; H01R 31/06

(52) U.S. Cl. CPC H01R 13/629; H01R 31/06

(57) ABSTRACT

A power adapter includes a body, a plug assembly and a guide member. The body includes a shell and a cover plate. The shell and the cover plate are engaged with each other along a first direction to form a first cavity. The shell includes a recessed portion in which a positioning plate is provided. The plug assembly includes a first housing and a second housing. The first housing and the second housing are engaged with each other along a second direction to form a second cavity. The second housing defines a slide groove. The guide member is located at least partially in the recessed portion. The guide member includes a plate portion, a first slot and a guide rail. The positioning plate is adapted to the first slot. The guide rail is adapted to the slide groove.

### CROSS-REFERENCE TO RELATED APPLICATION

This patent application claims priority of a Chinese Patent Application No. 202311813303.0, filed on Dec. 27, 2023 and titled “POWER ADAPTER”, the entire content of which is incorporated herein by reference.

### TECHNICAL FIELD

The present disclosure relates to the field of charging technology, and in particular, to a power adapter.

### BACKGROUND

In the prior art, a power adapter usually realizes the connection between a detachable plug and a body through a guide rail on a shell. After long-term use, the guide rail will become worn and the connection between the detachable plug and the body will become loose, which results in potential safety hazards and higher replacement costs.

Therefore, it is necessary to provide a new power adapter to solve the above problems.

### SUMMARY

An object of the present disclosure is to provide a power adapter that simplifies the connection structure between a plug assembly and a body, and strengthens the installation between the plug assembly and the body.

In order to achieve the above object, the present disclosure adopts the following technical solution: a power adapter, including: a body, the body including a shell and a cover plate, the shell and the cover plate being engaged with each other along a first direction to form a first cavity; the shell including a recessed portion in which a positioning plate is provided; a plug assembly, the plug assembly including a first housing and a second housing; the first housing and the second housing engaging with each other along a second direction to form a second cavity; the second housing defining a slide groove; the second direction is perpendicular to the first direction; and a guide member, the plug assembly being detachably connected to the body through the guide member; the guide member being at least partially located in the recessed portion; the guide member including a plate portion, a first slot and a guide rail; the first slot and the guide rail being provided on the plate portion; the positioning plate being adapted to the first slot; the guide rail being adapted to the slide groove.

In order to achieve the above object, the present disclosure adopts the following technical solution: a power adapter, including: a body, the body including a shell, a cover plate and a circuit board; the shell and the cover plate being engaged with each other to form a first cavity in which the circuit board resides; the shell including a connector port; a plug assembly, the plug assembly including a first housing, a second housing and another connector port configured to be coupled to the connector port; the first housing and the second housing engaging with each other; and a guide member, the plug assembly being detachably connected to the body through the guide member; the guide member being detachably assembled to the body along a first direction; the plug assembly being detachably assembled to the guide member along a second direction perpendicular to the first direction; the connector port and the another connector port are electrically connected with each other along the second direction.

In order to achieve the above object, the present disclosure adopts the following technical solution: a power adapter, including: a body, the body including a first cavity, a circuit board at least partially residing in the first cavity, and an electrical connection portion electrically connected to the circuit board; the body including a connector port; a plug assembly, the plug assembly including another connector port configured to be coupled to the connector port; and a guide member, the plug assembly being detachably connected to the body through the guide member; the guide member being detachably assembled to the body along a first direction; the plug assembly being detachably assembled to the guide member along a second direction perpendicular to the first direction; the connector port and the another connector port are electrically connected with each other along the second direction.

Compared with the prior art, the power adapter of the present disclosure has the following beneficial effects: by providing the guide member, the body defining the recessed portion to assemble the guide member, the guide member being provided with the first slot and the guide rail, the body being provided with a positioning plate adapted to the first slot, and the plug assembly being provided with the slide groove adapted to the guide rail, a detachable connection between the body and the plug assembly is achieved. Since the guide member, the body, and the plug assembly are all detachable designs, when the guide member becomes worn after long-term use, only the guide member needs to be replaced, which can reduce replacement costs. Besides, the power adapter simplifies the connection structure between the plug assembly and the body, making it easier to assemble and disassemble, and the connection is stronger.

### BRIEF DESCRIPTION OF DRAWINGS

FIG. 1 is a schematic perspective structural view of a power adapter in accordance with a specific embodiment of the present disclosure;

FIG. 2 is a schematic view of an exploded structure of the power adapter in accordance with a specific embodiment of the present disclosure;

FIG. 3 is a schematic assembly view of a body, a guide member and a second housing in accordance with a specific embodiment of the present disclosure;

FIG. 4 is a schematic structural view of a shell and the guide member in accordance with a specific embodiment of the present disclosure;

FIG. 5 is a schematic assembly view of the body and the guide member in accordance with a specific embodiment of the present disclosure;

FIG. 6 is a schematic exploded structural view of a plug assembly in accordance with a specific embodiment of the present disclosure;

FIG. 7 is a schematic view of the assembly structure of the guide member and the second housing in accordance with a specific embodiment of the present disclosure; and

FIG. 8 is a schematic top view of FIG. 7.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

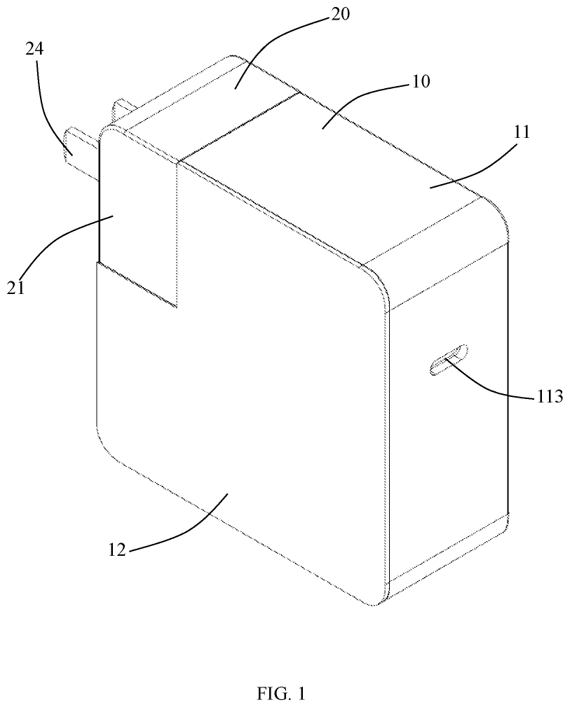

Referring to FIG. 1 to FIG. 7, an embodiment of the present disclosure discloses a power adapter, which includes a body 10, a plug assembly 20 and a guide member 30. The plug assembly 20 is detachably connected to the body 10 through the guide member 30. The power adapter is generally in the shape of a large rectangular parallelepiped. The plug assembly 20 is generally in the shape of a small rectangular parallelepiped. The body 10 defines a notch for receiving the plug assembly 20. The notch has a first surface 101 and a second surface 102 that are perpendicular to each other.

In order to facilitate the description of the embodiment of the present disclosure, a first direction, a second direction and a third direction are set to assist the description; wherein D1 in the drawings represents the first direction, D2 represents the second direction and D3 represents the third direction. Each two of the first direction, the second direction and the third direction are perpendicular to each other.

In this embodiment, the guide member 30 is made of metal and has high strength, so that the plug assembly 20 and the body 10 are connected more firmly. The guide member 30, the body 10, and the plug assembly 20 are designed to be detachable. When the guide member 30 becomes worn after long-term use, you only need to replace the guide member 30, which can reduce the replacement costs.

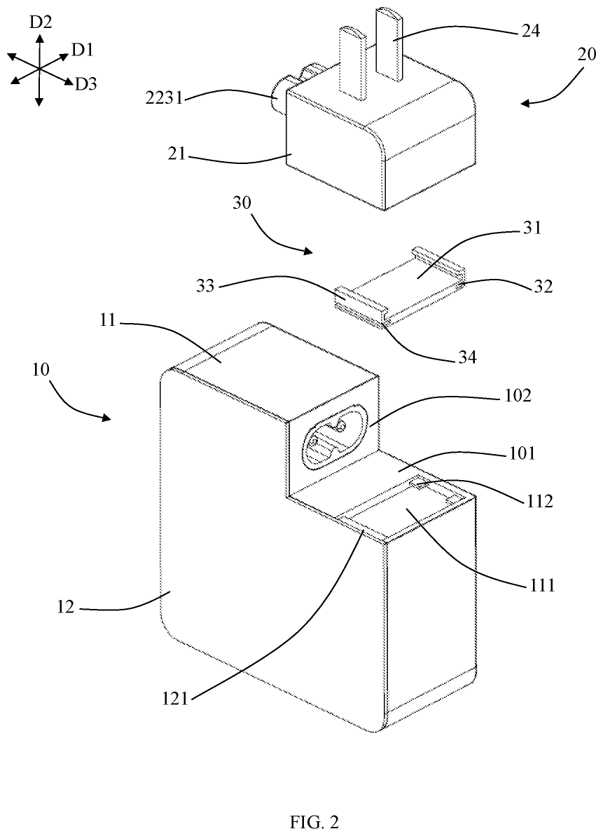

Referring to FIG. 2 to FIG. 4, the body 10 includes a shell 11 and a cover plate 12. The shell 11 and the cover plate 12 are engaged with each other along the first direction to form a first cavity 100. A recessed portion 111 is provided at the notch of the shell 11. The recessed portion 111 is provided on the first surface 101 for installing the guide member 30. The guide member 30 is at least partially located in the recessed portion 111. Specifically, a width of the guide member 30 in the first direction and a width of the guide member 30 in the third direction are adapted to the recessed portion 111. Furthermore, a positioning plate 112 is further provided in the recessed portion 111. The positioning plate 112 extends along the first direction from an inner surface of the recessed portion 111. The guide member 30 defines a first slot 32 correspondingly. The positioning plate 112 is adapted to the first slot 32. The positioning plate 112 is located at least partially within the first slot 32. In some embodiments, a width of the positioning plate 112 in the first direction is comparable to the first slot 32. The width of the positioning plate 112 in the second direction is equivalent to the first slot 32. In this way, the guide member 30 can be accurately installed to the body 10 so that it is relatively fixed to the body 10 in the second direction and the third direction.

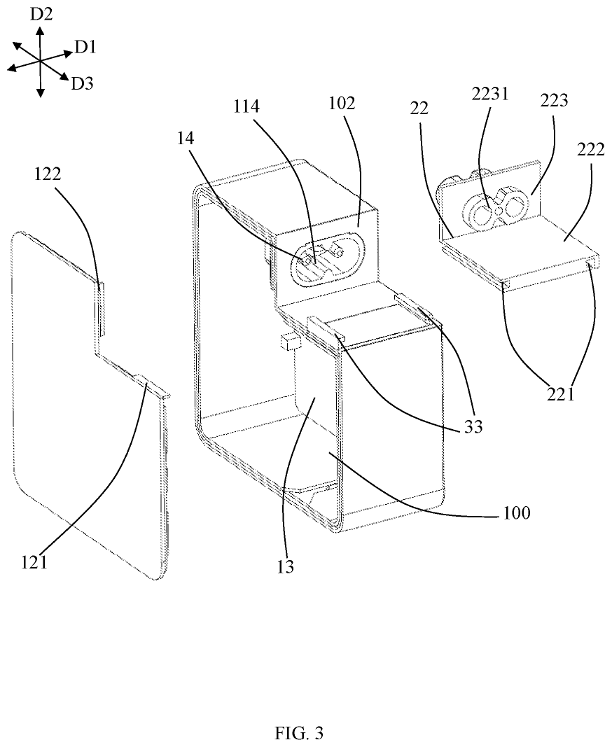

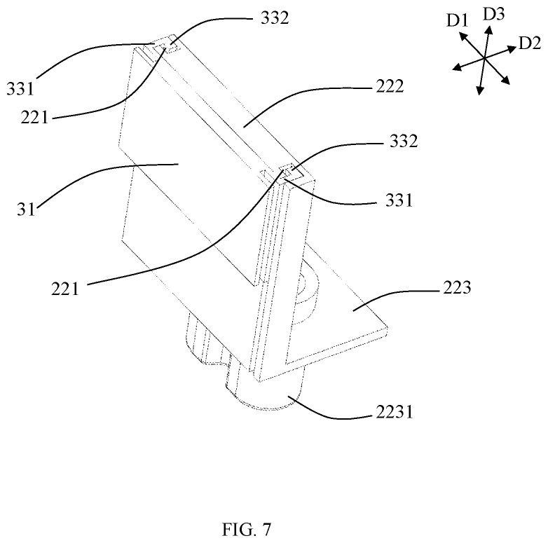

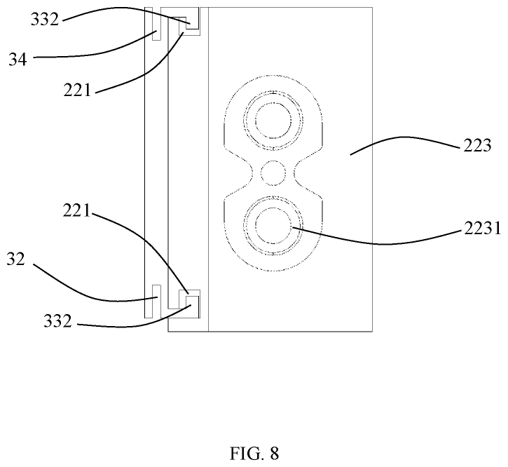

Referring to FIG. 3, FIG. 7 and FIG. 8, the plug assembly 20 includes a first housing 21 and a second housing 22. The first housing 21 and the second housing 22 are engaged with each other along the second direction to form a second cavity 200. The second housing 22 defines a slide groove 221. The guide member 30 further includes a plate portion 31 and a guide rail 33. The first slot 32 and the guide rail 33 are both provided on the plate portion 31. The guide rail 33 is adapted to the slide groove 221. Further, the second housing 22 includes a first base plate 222 and a second base plate 223. The slide groove 221 is provided on the first base plate 222. The first base plate 222 is connected to the shell 11 along the second direction. The second base plate 223 is connected to the shell 11 along the third direction. Specifically, the first base plate 222 is cooperatively connected with the first surface 101. The second base plate 223 is matched with the second surface 102. In this way, the plug assembly 20 can be accurately installed to the body 10 through the guide member 30.

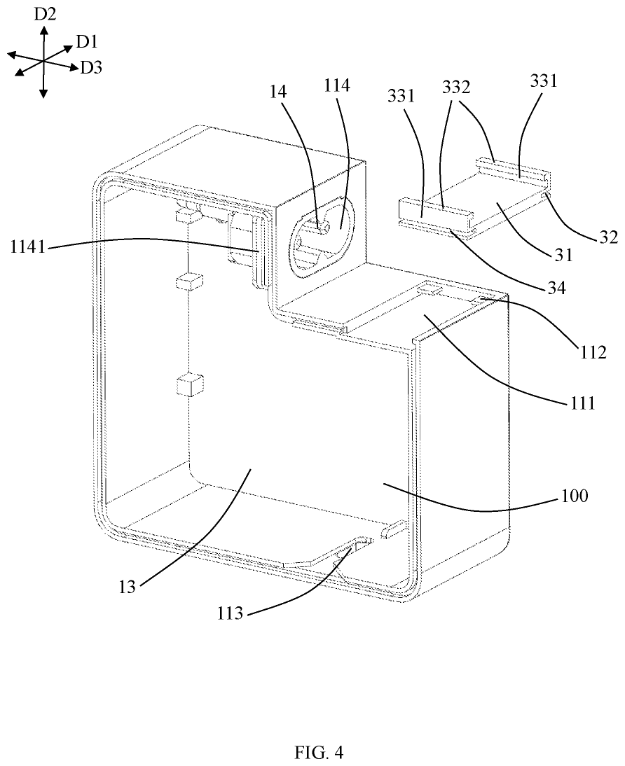

Furthermore, referring to FIG. 3, FIG. 4, FIG. 7 and FIG. 8, the guide rail 33 includes a first extension portion 331 and a second extension portion 332. The first extension portion 331 extends toward the second direction from a side of the plate portion 31 close to the plug assembly 20. The second extension portion 332 extends toward the first direction from an end of the first extension portion 331 away from the plate portion 31. In this embodiment, two first extension portions 331 and two second extension portions 332 are provided. The two first extension portions 331 extend toward a same side in the second direction from the side of the plate portion 31 close to the plug assembly 20. The two second extension portions 332 respectively extend from ends of the two first extension portions 331 away from the plate portion 31 toward a side closer to each other. Therefore, a distance between the two second extension portions 332 is smaller than a distance between the two first extension portions 331, which allows the plug assembly 20 to be moved only in the third direction for assembly and disassembly when the plug assembly 20 is engaged to the guide rail 33 through the slide groove 221 without unnecessary displacement in other directions.

Referring to FIG. 2 to FIG. 5, the cover plate 12 includes a first engaging portion 121. The guide member 30 defines a second slot 34. The first engaging portion 121 is adapted to the second slot 34. The first engaging portion 121 is at least partially located in the second slot 34. In some embodiments, a width of the first engaging portion 121 in the first direction is equivalent to that of the second slot 34. A width of the first engaging portion 121 in the second direction is equivalent to that of the second slot 34. Further, the first slot 32 and the second slot 34 are respectively provided on opposite sides of the guide member 30 in the first direction. In this embodiment, the first slot 32 and the second slot 34 are respectively recessed inwardly from two sides of the plate portion 31 in the first direction. The width of the first slot 32 in the second direction is smaller than the width of the plate portion 31. The width of the second slot 34 in the second direction is smaller than the width of the plate portion 31. In this way, the guide member 30 can be accurately and firmly installed to the body 10 so that it is relatively fixed to the body 10 in the first direction, and the installation of the cover plate 12 and the shell 11 is facilitated.

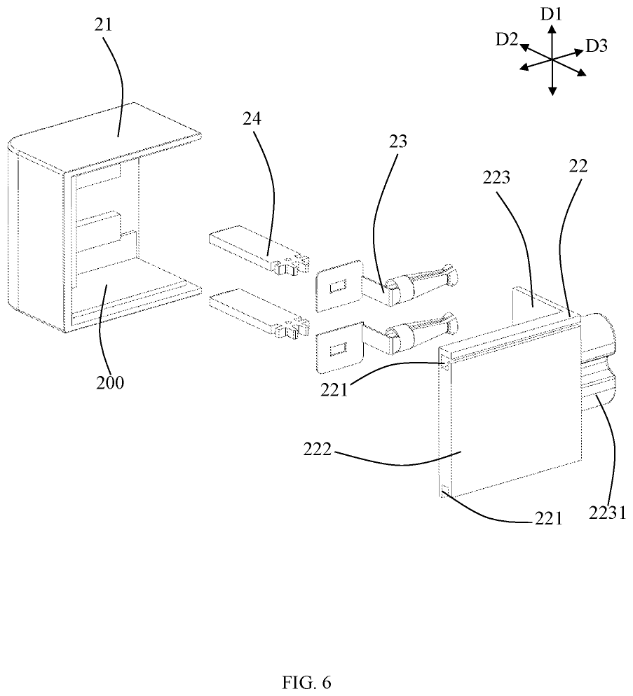

Referring to FIG. 3, FIG. 4 and FIG. 6, the second base plate 223 includes a first port 2231. The first port 2231 extends from the second cavity 200 along the third direction and extends through the second base plate 223 to an opposite side. That is, the first port 2231 connects the second cavity 200 with the outside. The shell 11 includes a second port 114. The second port 114 extends from the first cavity 100 along the third direction and extends through the second surface 102 to an opposite side. That is, the second port 114 connects the first cavity 100 with the outside. Further, when the second port 114 is adapted to the first port 2231, the first cavity 100 and the second cavity 200 are in communication.

Referring to FIG. 3, FIG. 4 and FIG. 6, the plug assembly 20 further includes terminals 23 and pins 24. Each pin 24 extends from the second cavity 200 along the second direction and extends through the first housing 21 to the outside of the second cavity 200. The terminal 23 connects to a corresponding pin 24 and is located at least partially in first port 2231. The body 10 further includes a circuit board 13 and an electrical connection portion 14. The circuit board 13 is fixed in the first cavity 100. The electrical connection portion 14 is connected to the circuit board 13 and is at least partially located in the second port 114. Further, when the plug assembly 20 is installed to the body 10, the first port 2231 and the second port 114 are adapted and connected, then the terminals 23 are connected to the electrical connection portion 14, and then the pins 24 are electrically connected to the circuit board 13. When the pins 24 are connected to an external circuit, it can be powered on.

Further, referring to FIG. 3 to FIG. 5, the second port 114 is located in the first cavity 100 and has a third slot 1141 on a side close to the cover plate 12. The cover plate 12 is provided with a second engaging portion 122. The second engaging portion 122 is adapted to the third slot 1141. The second engaging portion 122 is at least partially located in the third slot 1141. In this way, the cover plate 12 and the shell 11 can be more accurately and firmly assembled together.

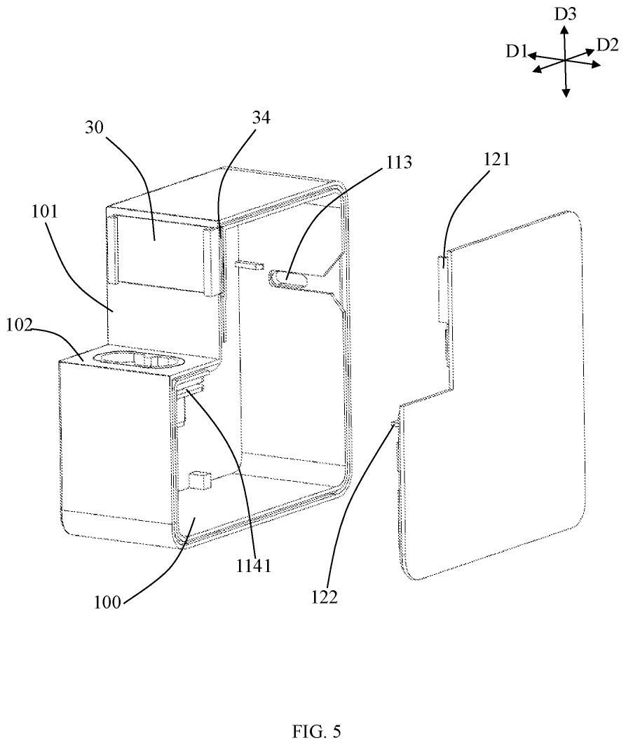

Referring to FIG. 1, FIG. 4 and FIG. 5, the shell 11 further defines a port 113. The port 113 connects the first cavity 100 with the outside. Further, the port 113 electrically connects the circuit board 13 with the outside. When the electronic device is connected to the port 113 and the pins 24 are connected to the external circuit, the electronic device can be charged.

When assembling the power adapter of the present embodiment, firstly, the guide member 30 is inserted into the recessed portion 111 of the shell 11 along the first direction, and the positioning plate 112 in the recessed portion 111 is inserted into the first slot 32 so as to fix the position of the guide member 30. Then, the first engaging portion 121 of the cover plate 12 is engaged with the second slot 34 of the guide member 30 along the first direction, and the second engaging portion 122 of the cover plate 12 is engaged with the third slot 1141 of the second port 114, thereby completing the installation of the cover plate 12. Finally, the plug assembly 20 is inserted along the guide rail 33 of the guide member 30 in the third direction, so that the first port 2231 is engaged with the second port 114 to complete the installation of the plug assembly 20.

In summary, compared with the prior art, the power adapter of the present disclosure has the following advantages: by providing the guide member 30, the body 10 defining the recessed portion 111 for mounting the guide member 30, the guide member 30 being provided with the first slot 32 and the guide rail 33, the body 10 being provided with the positioning plate 112 adapted to the first slot 32, and the plug assembly 20 being provided with the slide groove 221 adapted to the guide rail 33, a detachable connection between the body 10 and the plug assembly 20 is achieved. The power adapter simplifies the connection structure between the plug assembly 20 and the body 10, making it easier to assemble and disassemble, and the connection is stronger.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A power adapter, comprising:
a body, the body comprising a shell and a cover plate, the shell and the cover plate being engaged with each other along a first direction to form a first cavity; the shell comprising a recessed portion in which a positioning plate is provided;
a plug assembly, the plug assembly comprising a first housing and a second housing; the first housing and the second housing engaging with each other along a second direction to form a second cavity; the second housing defining a slide groove; the second direction is perpendicular to the first direction; and
a guide member, the plug assembly being detachably connected to the body through the guide member; the guide member being at least partially located in the recessed portion; the guide member comprising a plate portion, a first slot and a guide rail; the first slot and the guide rail being provided on the plate portion; the positioning plate being adapted to the first slot; the guide rail being adapted to the slide groove.

2. The power adapter according to claim 1, wherein the cover plate comprises a first engaging portion; the guide member defines a second slot; the first engaging portion is adapted to the second slot; the second slot and the first slot are respectively provided on opposite sides of the guide member.

3. The power adapter according to claim 1, wherein the second housing comprises a first base plate and a second base plate; the slide groove is provided on the first base plate; the second base plate is connected to the shell along a third direction; the third direction is perpendicular to the first direction and the second direction, respectively.

4. The power adapter according to claim 1, wherein the guide rail comprises a first extension portion and a second extension portion; the first extension portion extends from the plate portion toward the second direction; the second extension portion extends from an end of the first extension portion away from the plate portion and extends toward the first direction.

5. The power adapter according to claim 4, wherein two first extension portions and two second extension portions are provided; the two first extension portions extend from the plate portion toward a same side in the second direction; one of the two second extension portions extends from an end of one of the two first extension portions away from the plate portion and extends toward a remaining one of the two second extension portions; the remaining one of the two second extension portions extends from another end of a remaining one of the two first extension portions away from the plate portion and extends toward the one of the two second extension portions.

6. The power adapter according to claim 2, wherein the first slot and the second slot are respectively recessed inwardly from two sides of the plate portion in the first direction; a width of the first slot in the second direction is smaller than a width of the plate portion; and a width of the second slot in the second direction is smaller than the width of the plate portion.

7. The power adapter according to claim 3, wherein the second base plate comprises a first port; the first port extends from the second cavity along the third direction and extends through the second base plate to an opposite other side; the shell comprises a second port adapted to the first port.

8. The power adapter according to claim 7, wherein the second port comprises a third slot; the cover plate comprises a second engaging portion adapted to the third slot.

9. The power adapter according to claim 7, wherein the plug assembly further comprises a terminal and a pin; the pin extends from the second cavity along the second direction and extends through the first housing to an opposite side; the terminal is connected to the pin and is at least partially located in the first port.

10. The power adapter according to claim 9, wherein the body further comprises a circuit board and an electrical connection portion; the circuit board is fixed in the first cavity; the electrical connection portion connects the circuit board and the terminal.

11. A power adapter, comprising:
a body, the body comprising a shell, a cover plate and a circuit board; the shell and the cover plate being engaged with each other to form a first cavity in which the circuit board resides; the shell comprising a connector port;
a plug assembly, the plug assembly comprising a first housing, a second housing and another connector port configured to be coupled to the connector port; the first housing and the second housing engaging with each other; and
a guide member, the plug assembly being detachably connected to the body through the guide member; the guide member being detachably assembled to the body along a first direction; the plug assembly being detachably assembled to the guide member along a second direction perpendicular to the first direction; the connector port and the another connector port are electrically connected with each other along the second direction.

12. The power adapter according to claim 11, wherein the shell comprises a recessed portion and a positioning plate extending into the recessed portion; the guide member is assembled to the recessed portion along the first direction;
the second housing defines a slide groove; the guide member comprises a plate portion, a first slot and a guide rail; the positioning plate is inserted in the first slot; and the guide rail is inserted in the slide groove along the second direction.

13. The power adapter according to claim 11, wherein the cover plate comprises a first engaging portion; the guide member defines a second slot; the first engaging portion is fixed in the second slot.

14. The power adapter according to claim 12, wherein the second housing comprises a first base plate and a second base plate; the slide groove is provided on the first base plate; the second base plate is connected to the shell along a third direction; the third direction is perpendicular to the first direction and the second direction.

15. The power adapter according to claim 12, wherein the guide rail comprises a first extension portion and a second extension portion; the first extension portion extends from the plate portion toward the second direction; the second extension portion extends from an end of the first extension portion away from the plate portion and extends toward the first direction.

16. The power adapter according to claim 11, wherein the connector port defines a third slot; the cover plate comprises a second engaging portion fixed in the third slot.

17. The power adapter according to claim 11, wherein the body further comprises an electrical connection portion electrically connected to the circuit board;
the plug assembly comprises a terminal and a pin; the terminal is electrically connected to the pin; the terminal is electrically connected to the electrical connection portion; the pin is configured to be electrically connected to a power supply.

18. A power adapter, comprising:
a body, the body comprising a first cavity, a circuit board at least partially residing in the first cavity, and an electrical connection portion electrically connected to the circuit board; the body comprising a connector port;
a plug assembly, the plug assembly comprising another connector port configured to be coupled to the connector port; and
a guide member, the plug assembly being detachably connected to the body through the guide member; the guide member being detachably assembled to the body along a first direction; the plug assembly being detachably assembled to the guide member along a second direction perpendicular to the first direction; the connector port and the another connector port are electrically connected with each other along the second direction.

19. The power adapter according to claim 18, wherein the body comprises a recessed portion and a positioning plate extending into the recessed portion; the guide member defines a first slot configured to receive the positioning plate; the guide member is assembled to the recessed portion along the first direction.

20. The power adapter according to claim 18, wherein the guide member comprises a guide rail; the plug assembly defines a slide groove; and the guide rail is inserted in the slide groove along the second direction.
